(19) United States
(12) Patent Application Publication
(10) Pub. No.: US 2026/0354429 A1
(43) Pub. Date: Nov. 12, 2026

(54) VEGAN-BASED EGG SUBSTITUTE PRODUCT

(71) Applicant: NEGGST FOODS GMBH, Berlin (DE)

(72) Inventors: Veronica GARCIA ARTEAGA, Berlin (DE); Jana Frederike CZERWINSKE, Berlin (DE); Siegfried FÜRTAUER, Aachen (DE); Bernhard VAN LENGERICH, Plymouth, MN (US)

(21) Appl. No.: 19/131,789

(22) PCT Filed: Nov. 24, 2022
(86) PCT No.: PCT/EP2022/083155

§ 371 Date: May 21, 2025

(51) Int. Cl. A23L 15/00; A23J 3/14; A23J 3/22; A23L 5/44; A23L 29/212; A23L 29/256; A23L 29/262

(52) U.S. Cl. CPC A23L 15/35; A23J 3/14; A23J 3/225; A23L 5/44; A23L 29/212; A23L 29/256; A23L 29/262

(57) ABSTRACT

The invention relates to a vegan-based egg substitute product, comprising a mixture (1) of: (a) drinking water; (b) one or more proteins from pulses, oilseeds, grains, algae, or microorganisms; (c) vegetable oil, optionally containing at least one emulsifier; (d) a combination of one or more reversibly thermo-gelling hydrocolloid(s) with one or more reversibly gelling hydrocolloid(s); (e) at least one carotenoid-containing food and/or a natural colouring substance; (f) optionally at least one partially pregelatinised starch; and (f) salt; wherein the mixture (1) is surrounded by a casing made of a highly cross-linked hydrocolloid or thermo-reversibly gel-forming hydrocolloid, which is in turn surrounded by a mixture (2), comprising: (i) drinking water; (ii) one or more proteins from pulses, oilseeds, grains, microorganisms and/or algae; (iii) a combination of one or more thermo-gelling hydrocolloid(s) with one or more reversibly gelling hydrocolloid(s); (iv) one or more salt(s). The invention also relates to a method for producing the egg substitute product and to the use of the egg substitute product for producing an emulsion, in a meal or baked goods or a simulated fried egg.

### FIELD OF APPLICATION

The invention relates to a vegan-based egg substitute product.

### PRIOR ART

Awareness of the importance of a sustainable lifestyle also continually increases the importance of a purely plant-based diet. In addition to pure vegans and vegetarians, more and more people are trying to reduce the consumption of animal products (flexitarians and flexiganians). The latter leads to an increasing demand for and availability of plant-based foods that offer consumers a similar taste experience to that of the corresponding animal products.

Eggs are a high-quality source of protein and, in addition to direct consumption, perform many tasks in food such as forming emulsions and foams and stabilizing dough masses. Due to the wide range of possible uses, a vegan alternative for eggs which covers as many areas as possible is a major challenge.

Chicken egg yolk is a fat-in-water emulsion and contains about 30% fat, about 17% proteins, minerals, and vitamins in addition to just under 50% water. Due to the high content of phospholipids (about 30% of the fat), egg yolk is a very good emulsifier, the carotenoids contained therein lead to the characteristic yellow-orange color.

In the kitchen, egg yolk is mainly used as an emulsifier (for example for mayonnaises), for loosening, foaming and thickening creams, and for stabilizing crumbs in baked goods. Egg yolk solidifies when heated above 72 °C.

Chicken egg white makes up 55-60% of the total egg weight. In addition to 80-84% water, egg white contains 12% protein, 0.7% carbohydrates, 0.7% minerals, and 0.03% lipids. Depending on the freshness of the product, egg white has a pH of 7.6 to 9.7; the pH increases during storage due to the diffusion of CO₂ through the egg shell. Egg white contains various proteins: ovalbumin (54%), conalbumin (12%), ovomucoid (11%), and ovomucin (3.5%). Owing to its protein content and high-quality amino acid composition, egg white of animal origin is an important source of protein.

It has all amino acids essential for humans and therefore has a high protein value.

WO 2017/014967 A1 and WO 2017/014806 A1 relate to plant-based egg substitute compositions which are characterized by a high content of hydrocolloids.

WO 2019/220431 A1 also relates to egg substitute compositions which have more than 5% hydrocolloids.

WO 89/10704 relates to an egg substitute in which the egg yolk substitute is surrounded by a membrane and is combined with a natural protein or a treated protein or a protein analog.

There are already various other egg substitute products, the basis of which is usually a mixture of starches and hydrocolloids, in some cases also of plant-based proteins (US 2013/0084361 A1; DE 603 13 732 T2). They can be used as dry or liquid products in foods where they largely or partially take over the functions of egg yolk (comparable color, thickening). Some of these products also have a rheology similar to animal egg yolk. If these foods are brought into contact with a light water-containing food (e.g., egg white or egg white substitute) for a period of more than 7 days, the yellow or orange color diffuses from the “egg yolk” into the “egg white.” Thus, the egg yolk and egg white in free-flowing form are not stable in storage side by side without mixing. In addition, they do not have the characteristic curved shape of a fresh animal egg yolk.

### OBJECT OF THE PRESENT INVENTION

The object of the present invention is to provide a two-phase food on a vegan basis, which consists of at least one liquid phase, which is similar to an egg yolk, and of a liquid phase surrounding the egg yolk, which is similar to an egg white, wherein the two phases can be separated from one another by an intermediate layer, membrane or egg yolk surrounding shell, and the “egg yolk” can be brought into contact with the “egg white” for a period of at least 7 days without color equalization taking place, without the two materials mixing, and without both or one of the two liquid phases solidifying. This food is to allow being processed similar to animal egg, i.e., to solidify during heating.

### DESCRIPTION OF THE INVENTION

The object is achieved by a vegan-based egg substitute product comprising a mixture (1) of:
(a) drinking water
(b) one or more proteins derived from pulses, oilseeds, grains, algae, or microorganisms,
(c) vegetable oil, optionally containing at least one emulsifier,
(d) a combination of one or more reversibly thermo-gelling hydrocolloids with one or more reversibly gelling hydrocolloids,
(e) at least one carotenoid-containing food and/or natural coloring substance,
(f) optionally, at least one partially pregelatinized starch
(g) salt,
wherein the mixture (1) is enclosed by a shell of a highly crosslinked hydrocolloid or thermoreversibly gel-forming hydrocolloid, which in turn is surrounded by a mixture (2), comprising:
(i) drinking water
(ii) one or more proteins derived from pulses, oilseeds, grains, microorganisms, and/or algae,
(iii) a combination of one or more reversibly thermo-gelling hydrocolloids with one or more reversibly gelling hydrocolloids,
(iv) one or more salts.

The percentages mentioned in the following text are in each case wt. %.

“Vegan-based” means that the product does not contain any animal or animal-derived ingredients.

The mixture (1) according to the invention, hereinafter also referred to as “egg yolk” or “egg yolk substitute product,” preferably has a protein content of between 1% and 35%, advantageously between 3% and 25% or 20%, very advantageously between 4% and 15%, and particularly advantageously between 5% and 12%. Suitable sources of protein are plant-based raw materials from the group of pulses, grains, oilseeds, (micro) algae, and microorganisms, preferably peas (Pisum sativum), chickpeas (Cicer arientinum), garden beans (Phaseolus vulgaris), fava beans (Vicia fava), sweet lupins (Lupinus), lentils (Lens culinaris), corn (Zea mays), hemp (Cannabis sativa), yams (Ipomoea batatas), manioc (Manihot esculenta), table potatoes (Solanum tuberosum), pumpkin (Cucurbita), flax (Linum usitatissimum), rapeseed (Brassica napus), soy (Glycine max), oats (Avena sativa), duckweed (Lemna), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori algae and/or wakame algae, wherein pea, lupin, potato, chickpea, and fava bean proteins are particularly advantageous. The protein source used may be (crude and/or hydrolyzed and/or fermented) flours, protein concentrates, protein isolates, and/or any desired combinations thereof which can be obtained from the plants and parts of plants per se, their seeds, tubers, and/or fruits of the abovementioned raw materials. A person skilled in the art in the field of food technology is sufficiently aware of the processing and nutritional suitability of the plants and respective plant parts.

In some embodiments, transglutaminases may optionally be added to improve the texture of the protein solutions or emulsions. The effect of transglutaminases on texture lies in their ability to promote crosslinking of proteins at certain temperatures and time conditions. The amount of transglutaminases is preferably between 0.001% and 3.00%, more preferably 0.01%-1.5%, more preferably 0.1%-1.0%. The transglutaminases are activated while the protein solution or emulsion is heated to temperatures between 40 °C-60 °C for at least 15 minutes, preferably 30 minutes, 60 minutes, 90 minutes, or 120 minutes. The transglutaminase may, but need not, be microencapsulated and can preferably be inactivated during the preparation of the egg substitute product by pasteurization or UHT treatment (above 75 °C or 120 °C).

The fat content of the mixture (1) is preferably between 1% and 50%, advantageously between 5% and 30%, very advantageously between 10% and 25%, and particularly advantageously between 12% and 18%. Suitable fatty components are vegetable oils, for example olive oil, coconut oil, linseed oil, walnut oil, safflower oil, or peanut oil; however, taste-neutral oils such as rapeseed oil, sunflower oil, and/or corn germ oil are preferred. Advantageously, up to 20%, preferably 2-15%, more preferably 5-9%, based on the proportion of the fat component, of emulsifiers may be added to the fat component. These are, for example, (plant-based) lecithin (or ingredients thereof, such as phosphatidylcholine, phosphatidylserine, phosphatidylethanolamine, or phosphatidylinositol), ascorbyl palmitate, sodium phosphate, sodium pyrophosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate, or sorbitan monostearate.

In order to give the egg yolk substitute product the appropriate color, at least one carotenoid-containing food and/or natural colors are added as a further ingredient. Preparations of fruits, vegetables, and tubers, advantageously of tuber and root vegetables, for example of carrots, apricots, tomatoes, peppers, pumpkin, fennel, and/or yam, are suitable for this purpose. These are preferably cooked and processed into pulp or finely chopped. In some embodiments, the amount of carotenoid-containing foods in the egg yolk is less than 15.0% (e.g., less than 12.0%, less than 8.00%, less than 4.00%, less than 2.00%, less than 1.50%, or less than 0.50%). In some embodiments, the amount of carotenoid-containing foods in the egg yolk is 0.01%-10.0% (e.g., 0.50%-9.50%, 2.50%-7.50%, or 3.00%-5.50%). It has been found that the use of yams as a carotenoid-containing food surprisingly leads to the formation of a texture and color similar to the classic chicken egg yolk, wherein the use of yams also supports the protein content and fiber content and brings a starch component into the mixture, which has an advantageous effect on the texture. These are preferably cooked and processed into pulp or finely chopped. The amount of yams can be between 3% and 10%, advantageously between 5% and 8%. In the case of yam as a carotenoid-containing food, further addition of an at least partially pregelatinized starch is unnecessary (0%) or can be limited to a small amount of less than 0.5%. Otherwise, the addition of at least one (partially) pregelatinized starch is advisable, preferably in an amount of 0.5%-4%, more preferably 1.0%-3.0%. (Partially) pregelatinized starch is preferably obtained from corn starch, potato starch, or rice starch by mechanical processing in the presence of water with or without the use of heat. Some or all of the starch grains burst. The powder is then dried. Pre-gelatinized starch is a white to yellowish white powder that swells in cold water. It has good rheological properties and is suitable as a binder.

Other suitable preparations of fruit, vegetables, and tubers can be used to adjust the texture, mouthfeel, and color. The addition of preferably fat-soluble natural coloring substances such as carotenoids (e.g., β-carotene, lycopene, zeaxanthin), carrot extracts, curcumin, and water-sparingly soluble coloring substances such as riboflavin is also suitable for optimum color adjustment. These are used individually or in combination to achieve the desired hue. In some embodiments, the amount of natural coloring substances in the egg yolk is less than 2.00% (e.g., less than 1.50%, less than 1.00%, less than 0.75%, or less than 0.25%). In some embodiments, the amount of natural coloring substances in the egg yolk is 0.01%-2.00% (e.g., 0.25%-1.75%, 1.00%-0.50%, or 1.75%-0.25%). The color of the egg yolks can range from yellow to dark orange in the L*a*b* color space. The brightness (L*) can range from 70-85, advantageously from 75-80; the red-green (a*) can range from 15-30, advantageously from 19-25; the yellow-blue (b*) can range from 60-95, advantageously from 70-90, particularly advantageously from 75-88.

Salt is added to produce a chicken egg-like aroma. Preference is given to NaCl, KCl, NaH₂PO₄, Na₂HPO₄, Na- or K citrate, CaCl₂, Na₃PO₄, and/or Kala-Namak (black salt) or a salt comparable to Kala-Namak which has a proportion of sulfur compounds. For this purpose, in some embodiments, the amount of salt, preferably Kala-Namak salt, is less than 2.00%, e.g., less than 0.75%, less than 0.50%, less than 0.25%, or less than 0.10%.

The egg yolk substitute product may also contain small amounts (less than 10.0%, preferably less than 5%, 3% or 2%) of additional secondary components. These can be flavoring formulations, spices, dried vegetables or fruits, sugars, preservatives, thickeners, or health-promoting additives. Examples which may be mentioned here are iodine, vitamins (e.g., vitamin B₁, B₂, B₃, B₅, B₇, B₉, B₁₂, C, D₃ or E), and/or minerals (e.g., Ca or Mg).

For the adjustment of the desired viscosity and the solidification during heating, the egg substitute product contains hydrocolloids. A combination of one or more thermo-gelling hydrocolloids with one or more reversibly gelling hydrocolloids has proven to be advantageous, wherein the two types differ in their behavior in the event of temperature changes. The hydrocolloids which gel rapidly when the temperature is raised to >40 °C are called “thermo-gelling” or “thermoreversibly gel-forming” and are preferably modified celluloses, preferably methylcelluloses, hydroxyethylcelluloses, hydroxypropylmethylcellulose (HPMC), and/or hydroxypropylcellulose. However, the gelling brought about in this way is only temporary: upon cooling to <40°, the gel is converted back into the original viscous solution. To produce thermo-gelling, there should be a certain minimum concentration of thermo-gelling hydrocolloids, which is about 1.5 g/l in the case of methylcelluloses. A person skilled in the art can determine the minimum concentration for other thermo-gelling hydrocolloids without great experimental expenditure. Below this concentration, no gelling takes place when the aqueous solution is heated. Reversibly gelling hydrocolloids form gels at room temperature (about 20 °C) which, in contrast to the thermo-gelling hydrocolloids, melt on heating within a certain temperature interval, i.e., liquefy and form a viscous solution which, in turn, gels again after cooling to or below the gelling temperature. The reversibly gelling hydrocolloids used are those from algae, preferably carrageenan and/or agar. Other hydrocolloids are additionally used to adjust the desired consistency and support the permanent solidification of the vegan egg yolk, preferably gellan gum, locust bean gum, guar gum, alginate, and/or xanthan. In some embodiments, the amount of hydrocolloids in the egg yolk substitute product is less than 5.00% (e.g., less than 4.75%, 4.50%, 4.25%, 4.00%, 3.75%, 3.50%, 3.25%, 3.00%, 2.75%, 2.50%, 2.25%, 2.00%, 1.75%, 1.50%, 1.00%, 0.75%, or equal to or less than 0.50%). In some embodiments, the amount of hydrocolloids in the egg yolk substitute product is 0.10%-4.5% (e.g., 0.20%-4.00%, 0.25%-3.00%, 0.50%-2.50%, or 0.75%-2.00%). The division between thermo-gelling and reversibly gelling hydrocolloids is preferably 50:50, preferably 25:75, 30:70, respectively, or 40:60 or 75:25, 70:30 or 60:40, respectively. A quantity of hydrocolloids of less than 5.00% allows the provision of a liquid crude egg substitute, but on the other hand provides stability and texture, comparable to a chicken egg, during cooking.

In a preferred embodiment, the egg yolk substitute mixture is surrounded by a shell of a highly crosslinked hydrocolloid or thermoreversibly gelling hydrocolloid, preferably calcium alginate or k carrageenan.

The optimal amount of water depends to a certain extent on the exact composition of the egg yolk substitute product. This can be determined in a simple manner by first mixing in a relatively small amount of water. If the liquid egg yolk substitute is then still thicker than desired, even more water can be mixed in. Thus, the viscosity of the egg yolk substitute product is controlled by the addition of water to the aforementioned ingredients. The egg yolk substitute product may have an initial viscosity (prior to any heat or other treatment), defined as resistance to deformation at a given shear rate, in the range between 0.5 Pa·s and 200.0 Pa·s, preferably 0.7 Pa·s⁻¹⁵⁰ Pa·s; 1.51 Pa·s⁻¹⁰⁰ Pa·s or 50 Pa·s-80 Pa·s. On the other hand, after a heat treatment (e.g., cooking), the egg yolk may have a viscosity in the range of 100 Pa·s and 10,000 Pa·s, preferably 300 Pa·s-8,000 Pa·s, 700 Pa·s-3,500 Pa·s or 900 Pa·s-1,500 Pa·s. The viscosity can be measured by means of a rheometer (MCR301 SN802801740, Anton Paar GmbH, Graz, Austria) with a cylindrical measuring system (CC27-SN12031) with a measuring gap d=1.136 mm. The manner in which the viscosity measurement is to be carried out with a rheometer is known to a person skilled in the art. Only exemplary conditions are described below. The cylinder is filled, for example, with 15 ml of the sample. The sample is equilibrated for 5 minutes at 10 °C and left for measurement. The rotation is increased linearly from 2-100 s⁻¹ within 60 s. The rotation of 100 s⁻¹ is maintained for 30 s before decreasing from 100-2 s⁻¹ within 60 s. Viscosity is adjusted based on a given protein type and concentration by the addition of water, hydrocolloids, salt, and buffer salts and is carried out experimentally by measuring the viscosities.

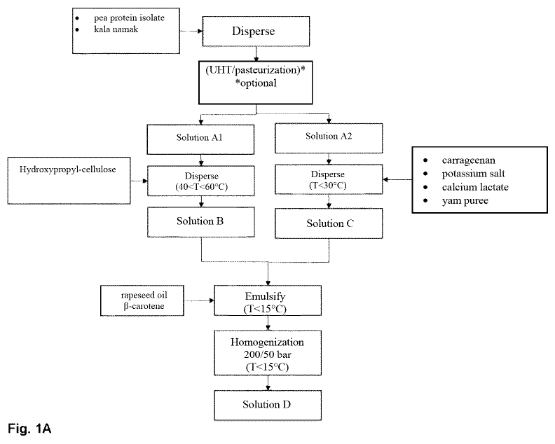

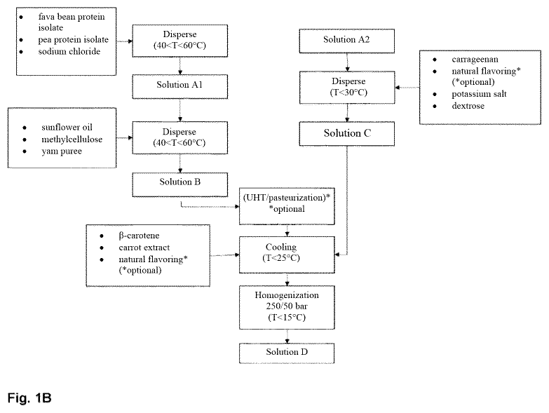

As shown in more detail in FIGS. 1A and 1B, the protein source is dispersed in water or an aqueous salt solution (solution (A)) for the preparation of mixture (1). Solution (A) can be divided into two parts ((A1) and (A2)). However, it is also possible to prepare two solutions (A1) and (A2) independently of one another: (A1) can be an aqueous protein or protein-salt solution and (A2) can be that of another protein or just water. Optionally, 0.001%-2.00% transglutaminase can be added to solution (A1). If unencapsulated transglutaminase is used, the solution should be maintained at 50 °C for less than 120 minutes. Solution (B) is prepared by heating solution (A1) to at least 40 °C, preferably 50 °C, but not more than 60 °C, and adding one or more thermo-gelling hydrocolloids (e.g., modified cellulose, methylcellulose, and/or hydroxypropylcellulose). The effect of heat results in improved dispersion of the hydrocolloids. Before or after dispersion of the hydrocolloids, oil (optionally containing 0.01%-50% emulsifiers), a calcium ion source, natural coloring substances, and optionally further additives are mixed in solution (B). Solution (C) is prepared by mixing solution (A2) with one or more reversibly gelling hydrocolloids at a temperature below 30 °C, preferably below 20 °C, 15 °C, or 10 °C. In addition, natural flavorings, flavoring formulations, oil and (encapsulated) transglutaminase or other additives can be mixed in solution (C). As soon as all the components of the solutions (B) and (C) are completely dispersed, the solutions (B) and (C) are mixed at a temperature preferably below 30 °C, as a result of which the finished egg white solution (solution (D)) is formed. The above-described solutions and dispersions are prepared in standard mixing vessels using known dispersion techniques.

The independent solutions and their mixture are preferably, but not necessarily, carried out under vacuum treatment. The vacuum can prevent the formation of air bubbles in the egg yolk.

The following four methods are preferably suitable for bead formation to provide a shell around the egg yolk for separation from the egg white.

METHOD 1: For bead formation (encapsulation), a soluble calcium salt (e.g., calcium lactate or calcium chloride) is introduced as part of the ingredients in solution (B) and/or (C) and the solution (B) and/or (C) is further processed to solution (D) as described above. The solution (D) containing the calcium salt should be metered as bead-shaped as possible into an aqueous solution of a highly crosslinking hydrocolloid, preferably sodium alginate, and should remain in contact with this solution for a maximum of 5 minutes, better less than 4 minutes, and even better less than 3 minutes, so that the filling (solution (D)) remains liquid. Solution (D) can be frozen or frozen beforehand in bead-shaped molds for then being added to a lukewarm bath of the highly crosslinking hydrocolloid for capsule formation. By diffusion of calcium ions from the solution (D) into the solution of the highly crosslinking hydrocolloid, an outer shell is formed and encapsulates the egg yolk (=solution (D)) by a crosslinking reaction of the highly crosslinking hydrocolloid with the calcium ions. In other words, a surface layer is formed around the solution (D), resulting in a shape that closely resembles a known animal egg yolk. The encapsulated egg yolk should be rinsed with water as soon as possible to stop the crosslinking reaction. The amount of hydrocolloid surrounding the solution (D) is not more than 1% of the total weight of the encapsulated egg yolk.

In a preferred embodiment of method 1, the liquid “egg yolk” (solution (D)) is metered into a hydrocolloid (preferably sodium alginate) solution as a bead-shaped, contiguous body (weight: between 5 and 20 g) with the aid of a nozzle into a hydrocolloid (preferably sodium alginate) solution and brought into contact with this solution for a period of less than 300 seconds, preferably less than 240 seconds, 120 seconds, or 60 seconds. The encapsulated egg yolk can then be rinsed in a demineralized water bath to remove excess alginate, such that the “egg yolk” does not cure during storage and remains liquid inside. Surprisingly, the liquid product remains so stable in its encapsulation that it can be transferred intact into a bowl/pan, so that it remains convex there and the liquid content only runs out by stirring/deliberate destruction of the casing.

METHOD 2: For the bead formation (encapsulation), a highly crosslinking hydrocolloid (e.g., sodium alginate) is introduced as part of the ingredients in solution (B and/or C) and the solution (B and/or C) is further processed to solution (D) as described above. The solution (D) containing the highly crosslinked hydrocolloid should be metered in an as bead-shaped form as possible into an aqueous calcium salt solution (e.g., calcium lactate or calcium chloride) and should remain in contact with this solution for a maximum of 5 minutes, better less than 4 minutes, and even better less than 3 minutes, such that the filling (solution (D)) remains liquid. Solution (D) can be frozen beforehand in bead-shaped molds or frozen, for then to be added to a lukewarm calcium salt bath for capsule formation. By diffusing calcium ions from the calcium salt solution, an outer shell is formed and encapsulates the egg yolk (=solution (D)) by means of a crosslinking reaction between the highly crosslinking hydrocolloid and the calcium ions. In other words, a surface layer is formed around the solution (D), resulting in a shape that closely resembles a known animal egg yolk. The encapsulated egg yolk should be rinsed with water as soon as possible to stop the crosslinking reaction. Surprisingly, the liquid product remains so stable in its encapsulation that it can be transferred intact into a bowl/pan, so that it remains convex there and the liquid content only runs out by stirring/deliberate destruction of the casing. The amount of calcium salt surrounding the solution (D) is not more than 1% of the total weight of the encapsulated egg yolk.

METHOD 3: For forming a bead shape, the egg yolk formulation (solution (D)) described is deep-frozen in suitable molds of silicone rubber, plastic, stainless steel or the like at temperatures <0 °C, typically at −18 °C and below. The beads or hemispheres obtained from frozen solution D having diameters between 1 and 4 cm, ideally about 2-3 cm, are then further cooled using liquid nitrogen (boiling point −196 °C) until no noticeable gas bubble development takes place at the surface of the spheres (reaching thermodynamic equilibrium). A previously prepared solution of a thermoreversibly gelling hydrocolloid, typically sodium alginate and/or k-carrageenan, is dissolved in water at temperatures above 35 °C to obtain a clear 1-2% solution. This solution is then cooled down to temperatures between 35 °C and 50 °C, ideally in the range of 45-50 °C. The deep-frozen beads of solution D are then immersed in the hydrocolloid solution, such that a gel layer is formed on the surface by means of cooling. The thickness of the gel layer can be adjusted by means of immersion time, bead size, and supplied amount of hydrocolloid solution, and is 1-5 mm, typically about 1-2 mm. In other words, a surface layer is formed around the solidified solution (D), resulting in a shape that closely resembles a known animal egg yolk. Surprisingly, the liquid product remains so stable in its encapsulation after defrosting that it can be transferred intact into a bowl/pan, so that it remains convex there and the liquid content only runs out by stirring/deliberate destruction of the casing. The amount of thermoreversibly gelling hydrocolloid surrounding the solution (D) is not more than 1% of the total weight of the encapsulated egg yolk.

METHOD 4: For forming a bead shape, the egg yolk formulation (solution (D) without a calcium ion source) described is deep-frozen in suitable molds of silicone rubber, plastic, stainless steel or the like at temperatures <0 °C, typically at −18 °C and below. Optionally, the beads or hemispheres obtained from frozen solution D having diameters between 1 and 4 cm, ideally about 2-3 cm, are then further cooled using liquid nitrogen (boiling point −196 °C) until no noticeable gas bubble development takes place at the surface of the spheres (reaching thermodynamic equilibrium). The beads or hemispheres can be either sprayed on the surface with a liquid containing calcium ions or coated with a thin layer of a calcium salt such that the ions adhere to the frozen surface. A previously prepared solution of a thermoreversibly gelling hydrocolloid, typically sodium alginate and/or k-carrageenan, is dissolved in water at temperatures above 35 °C to obtain a clear 1-3% solution.

This solution is then cooled down to temperatures between 35 and 50 °C, ideally in the range of 45-50 °C. The deep-frozen beads, which ideally have a homogeneous layer of calcium ions on the surface, are subsequently immersed in the hydrocolloid solution, such that a gel layer is formed on the surface by means of cooling. The thickness of the gel layer can be adjusted by means of immersion time, bead size, and supplied amount of hydrocolloid solution, and is 1-5 mm, typically about 1-2 mm. In other words, a surface layer is formed around the solidified solution (D), resulting in a shape that closely resembles a known animal egg yolk. Surprisingly, the liquid product remains so stable in its encapsulation after defrosting that it can be transferred intact into a bowl/pan, so that it remains convex there and the liquid content only runs out by stirring/deliberate destruction of the casing. The amount of thermoreversibly gelling hydrocolloid surrounding the solution (D) is not more than 1% of the total weight of the encapsulated egg yolk.

The encapsulated egg yolk can be stored in a preservation and/or buffer solution which contains, for example, NaCl, calcium salt, benzoic acid, and/or ascorbic acid.

The encapsulated egg yolk substitute product is now being combined with an egg white replacement product to provide a two-phase egg substitute product commonly suitable for the production of a “fried egg.”

However, the mixture (2) according to the invention, hereinafter also referred to as “egg white,” “egg white,” “egg white substitute product,” or “egg white substitute product,” is prepared beforehand. It preferably has a protein content of 0.1 to 15%. In some embodiments, the amount of dissolved proteins is more than 1.0%, preferably more than 2.5%, more than 4.0%, more than 5%, more than 8%, more than 100% or more than 12%. In some embodiments, the amount of dissolved proteins is 0.5% to 15.0%, preferably 1.0%-12.0%, 1.5%-10%, or 2.0%-5.0% in the egg white replacement product according to the invention. Suitable sources of protein are plant-based raw materials from the group of pulses, grains, oilseeds, (micro) algae, and microorganisms, preferably peas (Pisum sativum), chickpeas (Cicer arientinum), garden beans (Phaseolus vulgaris), fava beans (Vicia fava), sweet lupins (Lupinus), lentils (Lens culinaris), corn (Zea mays), hemp (Cannabis sativa), yams (Ipomoea batatas), manioc (Manihot esculenta), table potatoes (Solanum tuberosum), pumpkin (Cucurbita), flax (Linum usitatissimum), rapeseed (Brassica napus), soy (Glycine max), oats (Avena sativa), duckweed (Lemna), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori algae and/or wakame algae, wherein pea, chickpea, fava bean, lupin, and mung bean are particularly advantageous. The protein source used may be (hydrolyzed) flours, protein concentrates, protein isolates, and/or any desired combinations thereof which can be obtained from the plants and parts of plants per se, their seeds, tubers, and/or fruits of the abovementioned raw materials. A person skilled in the art in the field of food technology is sufficiently aware of the processing and nutritional suitability of the plants and respective plant parts.

According to the invention, a transparent white product is provided which is produced from the aforementioned proteins from one or more plant protein sources. The solubility of the proteins is higher in salt solutions than in pure water. Therefore, to dissolve the proteins from drinking water and an inorganic salt suitable for consumption, a salt solution, preferably a sodium chloride (NaCl) solution, is prepared and the protein source is dispersed therein. In principle, however, other salts such as sodium dihydrogen phosphate (NaH₂ PO₄), disodium hydrogen phosphate (Na₂HPO₄), trisodium phosphate (Na₃PO₄), sodium pyrophosphate (Na₄P₂O₇), and furthermore potassium chloride (KCl) are also suitable. It is of course also possible to disperse the protein source and the salt simultaneously in drinking water. In some embodiments, the salt concentration, preferably NaCl concentration, is greater than 0.05%, preferably greater than 0.10%, greater than 0.15%, greater than 0.20%, greater than 0.30%, greater than 0.40%, or greater than 0.50%. In some embodiments, the salt concentration, preferably NaCl concentration, is 0.05%-0.80%, preferably 0.10%-0.70%, 0.20%-0.60%, or 0.4%-0.6%.

For generating an egg-like flavor, either kala namak (black salt) or other salts and/or natural flavorings containing a proportion of sulfur compounds may be used. The sulfur-containing compounds, in particular the kala namak salt, can be used together with the salt of the salt solution, preferably NaCl, to obtain the same concentrations. However, the kala namak salt can also be used in smaller, larger or equal amounts.

The amount of dissolved proteins in egg white substitute is preferably more than 0.1%. In some embodiments, the amount of dissolved proteins is more than 1.0%, preferably more than 2.5%, more than 4.0%, more than 5.0%, more than 8.0%, more than 10.0%, or more than 12%. In some embodiments, the amount of dissolved proteins is 0.5% to 15.0%, preferably 1.0%-12.0%, 1.5%-10.0%, or 2.0%-5.0% in the egg white substitute product according to the invention.

The egg substitute product contains hydrocolloids for adjusting the desired viscosity and the solidification during heating. A combination of one or more thermo-gelling with one or more reversibly gelling hydrocolloids has proven to be advantageous, wherein the two types differ in their behavior in the event of temperature changes. The hydrocolloids which gel rapidly when the temperature is raised to >40 °C are called “thermo-gelling” or “thermoreversibly gel-forming” and are preferably modified celluloses, preferably methylcelluloses, hydroxyethylcelluloses, hydroxypropylmethylcellulose (HPMC), and/or hydroxypropylcelluloses. However, the gelling brought about in this way is only temporary: upon cooling to <40°, the gel is converted back into the original viscous solution. To produce thermo-gelling, there should be a certain minimum concentration of thermo-gelling hydrocolloids, which is about 1.5 g/l in the case of methylcelluloses. A person skilled in the art can determine the minimum concentration for other thermo-gelling hydrocolloids without great experimental expenditure. Below this concentration, no gelling takes place when the aqueous solution is heated. Reversibly gelling hydrocolloids form gels at room temperature (about 20 °C) which, in contrast to the thermo-gelling hydrocolloids, melt on heating within a certain temperature interval, i.e., liquefy and form a viscous solution which, in turn, gels again after cooling to or below the gelling temperature. The reversibly gelling hydrocolloids used are those from algae, preferably carrageenan and/or agar. Other hydrocolloids are additionally used to adjust the desired consistency and support the permanent solidification of the vegan egg white, preferably gellan gum, locust bean gum, guar gum, alginate, and/or xanthan. According to the invention, the amount of hydrocolloids in the egg yolk substitute product is less than 5.00% (e.g., less than 4.75%, 4.50%, 4.25%, 4.00%, 3.75%, 3.50%, 3.25%, 3.00%, 2.75%, 2.50%, 2.25%, 2.00%, 1.75%, 1.50%, 1.00%, 0.75%, or equal to or less than 0.50%). In some embodiments, the amount of hydrocolloids in the egg yolk substitute product is 0.10%-4.5% (e.g., 0.20%-4.00%, 0.25%-3.00%, 0.50%-2.50%, or 0.75%-2.00%). The division between thermo-gelling and reversibly gelling hydrocolloids is preferably 50:50, preferably 25:75, 30:70, respectively, or 40:60 or 75:25, 70:30 or 60:40, respectively. A quantity of hydrocolloids of less than 5.00% allows the provision of a liquid crude egg substitute, but on the other hand provides stability and texture, comparable to a chicken egg, during cooking.

In some embodiments, vegetable oils can optionally be added to the mixture (2). The amount is preferably between 0.1% and 4%, preferably between 0.5 and 2.0%. Vegetable oils are suitable, for example olive oil, coconut oil, linseed oil, walnut oil, safflower oil, or peanut oil; however, preference is given to flavorless fats such as rapeseed oil, sunflower oil, coconut fat, and/or corn germ oil and any combinations thereof.

In some embodiments, transglutaminases may optionally be added to mixture (2) to improve the texture of the protein solutions or emulsions. The effect of transglutaminases on texture lies in their ability to promote crosslinking of proteins at certain temperatures and time conditions. The amount of transglutaminases is preferably between 0.001% and 3.00%, more preferably 0.01%-1.5%, still more preferably 0.1%-1.0%. The transglutaminases are activated while the protein solution or emulsion is heated to temperatures between 40 °C-60 °C for at least 15 minutes, preferably 30 minutes, 60 minutes, 90 minutes, or 120 minutes. The transglutaminase may, but need not, be microencapsulated and can preferably be inactivated during the preparation of the egg substitute product by pasteurization or UHT treatment (above 75 °C or 120 °C).

To produce a browning of the product during heating, for example during frying of a “fried egg,” which is produced by a so-called Maillard reaction, a small amount of sugar is preferably added to the mixture (2). The sugars are preferably monosaccharides (e.g., dextrose, fructose, and/or galactose) and/or disaccharides (e.g., lactose and/or maltose). In some embodiments, the amount of sugar in the egg white is less than 1.00%, preferably less than 0.75%, less than 0.50%, less than 0.25%, or less than 0.10%. In some embodiments, the amount of sugar in the egg white is 0.10%-1.00%, preferably 0.25%-0.75%, 0.50%-0.50%, or 0.75%-0.25%.

To prepare the mixture (2), the protein source(s) and the salt are dispersed in drinking water. The pH is adjusted between 6 and 9, preferably higher than 8.0, very preferably by 8.5, with pH food regulators such as sodium hydroxide (NaOH), potassium phosphate (K₃PO₄), or sodium citrate (Na₃ C₆H₅O₇). The solution is preferably stirred for at least 1 minute, preferably 5-10 minutes, even better for 15 minutes, in order to improve the swelling of the proteins. It is preferred, but not necessary, to separate the proteins after swelling by means of suitable separation methods, preferably centrifugation, decantation, or membrane filtration. This separation results in a supernatant containing the soluble proteins and a pellet containing insoluble proteins. According to the salt concentration in the solutions used, the soluble proteins are mainly globulins and albumins. The supernatant solution (solution (A)) is further used for the preparation of egg whites, while the residue or pellet can be used for the preparation of other products, e.g., a vegan egg yolk substitute product.

In order to simulate the consistency of chicken egg white, the mucous water from the hydration or the cooking of seeds, such as linseed or chia seeds, can preferably be used. The hydration can take place in water or in a soluble protein solution.

The egg white substitute product may also contain small amounts (less than 10.0%, preferably less than 5%, 3%, or 2%) of additional secondary components. These can be flavoring formulations, spices, preservatives, thickeners, or health-promoting additives. Examples which may be mentioned here are iodine, vitamins (e.g., vitamin B₁, B₂, B₃, B₅, B₇, B₉, B₁₂, C, D₃ or E), and/or minerals (e.g., Ca or Mg).

The egg white may have an initial viscosity defined as resistance to deformation at a given speed, in the range between 0.005 Pa·s and 20.0 Pa·s, preferably 0.1 Pa·s-19 Pa·s, 1.0 Pa·s-15 Pa·s or 5.0 Pa·s-10.0 Pa·s. The viscosity can be measured by means of a rheometer (MCR301 SN802801740, Anton Paar GmbH, Graz, Austria) with a cylindrical measuring system (CC27-SN12031) with a measuring gap d=0 mm. The manner in which the viscosity measurement is to be carried out with a rheometer is known to a person skilled in the art. Only exemplary conditions are described below. The cylinder is filled, for example, with 15 ml of the sample. The sample is equilibrated for 5 minutes at 10 °C and left for measurement. The rotation is increased linearly from 2-100 s⁻¹ within 60 s. The rotation of 100 s⁻¹ is maintained for 30 s before decreasing from 100-2 s⁻¹ within 60 s. Viscosity is adjusted based on a given protein type and concentration by the addition of water, hydrocolloids, salt, and buffer salts and is carried out experimentally by measuring the viscosities.

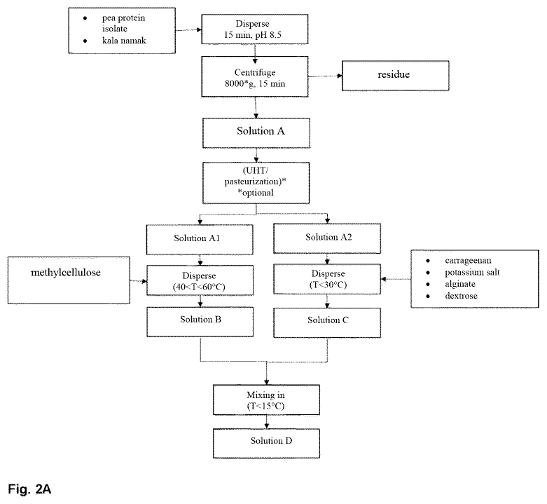

As shown in more detail in FIGS. 2A and 2B, the protein source is dispersed in water or an aqueous salt solution (solution (A)) for the preparation of mixture (2). Solution (A) can be divided into two parts ((A1) and (A2)). However, it is also possible to prepare two solutions (A1) and (A2) independently of one another: (A1) can be an aqueous protein or protein-salt solution and (A2) can be that of another protein or just water. Optionally, 0.001%-2.00% transglutaminase can be added to solution (A1). If unencapsulated transglutaminase is used, the solution should be maintained at 50 °C for less than 120 minutes. Solution (B) is prepared by heating solution (A1) to at least 40 °C, preferably 50 °C, but not more than 60 °C, and adding one or more thermo-gelling hydrocolloids (e.g., modified cellulose, methylcellulose, and/or hydroxypropylcellulose). The effect of heat results in improved dispersion of the hydrocolloids. Before or after dispersion of the hydrocolloids, oil (optionally containing 0.01%-50% emulsifiers), a calcium ion source, natural coloring substances, and optionally further additives are mixed in solution (B). Solution (C) is prepared by mixing solution (A2) with one or more reversibly gelling hydrocolloids at a temperature below 30 °C, preferably below 20 °C, 15 °C, or 10 °C. In addition, natural flavorings, flavoring formulations, oil and (encapsulated) transglutaminase or other additives can be mixed in solution (C). As soon as all the components of the solutions (B) and (C) are completely dispersed, the solutions (B) and (C) are mixed at a temperature preferably below 30 °C, as a result of which the finished egg white solution (solution (D)) is formed. The above-described solutions and dispersions are prepared in standard mixing vessels using known dispersion techniques.

The preparation of the solutions is preferably carried out under vacuum treatment, but this is not absolutely necessary. The vacuum can prevent the formation of air bubbles in the egg white substitute. Surprisingly, the degree of transparency increases when the vacuum is lowered to an absolute pressure of less than 800 mbar, preferably less than 500 mbar, advantageously less than 300 mbar, particularly advantageously less than 100 mbar or 50 mbar.

Various methods can be used for the preparation of a two-phase egg substitute product according to the invention. The encapsulated egg yolk can be placed, for example, in a vessel (e.g., cup, packaging, spheres) or an (artificial) egg shell in which the protein replacement product has already been filled beforehand. However, it is also possible to proceed in reverse, i.e., to first add the encapsulated egg yolk to the vessel/shell and then to fill in the egg whites.

For example, a technique which is already known for the production of microcapsules or “bubble tea” beads can be modified accordingly to form larger beads or spheres into which the encapsulated egg yolk substitute product described above can then be filled. However, it is also possible to allow the encapsulation of the egg yolk mixture with, for example, alginate/calcium solution to take place directly in the sphere and then to wash away any excess alginate/calcium bath with water.

In an alternative embodiment, the egg yolk substitute product can be placed in a silicone mold of an ellipse or sphere or semi-ellipse or semi-sphere. An appropriate freezing method is then used:
(a) If calcium or alginate is contained in the egg yolk substitute mixture, the frozen sphere is added to a warm alginate or calcium bath at a temperature higher than 30 °C, preferably 45 °C, more preferably 60 °C. The frozen spheres are placed in a warm bath which allows thawing of the superficial calcium ions/alginates so that crosslinking can take place.
(b) If neither calcium nor alginate is present in the egg yolk substitute mixture, the frozen spheres may be placed in a cold calcium bath at temperatures below 10 °C, followed by a warm alginate bath at temperatures higher than 30 °C, preferably 45 °C, more preferably 60 °C. Alternatively, the frozen spheres can be covered with a powder containing calcium ions before they are placed in the warm bath. In other words, the beads or hemispheres can be either sprayed on the surface with a liquid containing calcium ions or coated with a thin layer of a calcium salt such that the ions adhere to the frozen surface.

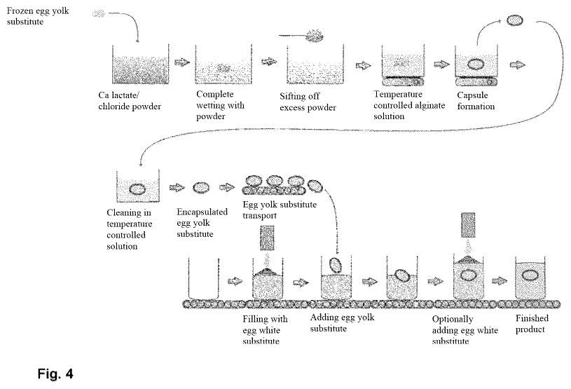

The preparation is described by way of example in FIG. 4.

For each of the above-mentioned methods, the egg yolk substitute product obtained can be metered continuously by suitable metering devices into prepared containers in which the liquid protein phase is located, wherein the ratio of egg yolk substitute product to egg white substitute product corresponds approximately to that of an animal egg.

The egg substitute product according to the invention obtained can be pasteurized or treated with high heat (at least 70 °C). For this purpose, suitable methods are sufficiently known to a person skilled in the art. Thermal or non-thermal processes, such as high-pressure pasteurization (HPP) or pulsed electric field (PEF) technology, can be used for this purpose.

A particularly preferred embodiment of the present invention comprises:

| | Quantity | ranges |
|---|---|---|
| Ingredient | (wt. %) | (wt. %) |
| NaCl | 0.38 | 0.2-0.6 |
| Protein source (e.g., | 11.80 | 2.0-15.0 |
| color bean protein or | | |
| pea protein) | | |
| Citric acid salts | 0.000 | 0.0-1.25 |
| Calcium lactate | 0.000 | 0.0-1.0 |
| Yam | 1.50 | 3.0-8.0 |
| Beta-carotene/carrot | 0.14 | 0.05-2.25 |
| extract | | |
| Vegetable oil (e.g., | 5.45 | 3.0-20.0 |
| sunflower oil or | | |
| rapeseed oil) | | |
| Methylcellulose | 1.36 | 0.1-2.5 |
| Carrageenan | 1.34 | 0.1-2.5 |
| Xanthan | 0.000 | 0.0-2.5 |
| Potassium chloride | 0.14 | 0.0-1.5 |
| Dextrose | 0.18 | 0.0-1.5 |
| Natural flavors | 1.000 | 0.0-2.5 |
| Vitamin D3 | 0.000001 | 0.0-0.001 |
| Vitamin B12 | 0.0000005 | 0.0-0.0005 |
| Water | remainder | remainder |
| | (77.33) | (38.90-91.55) |

The invention is further illustrated by the figures which show:

FIGS. 1A, B: diagrams for the production of an egg yolk substitute product

FIGS. 2A, B: diagrams for the production of an egg white substitute product

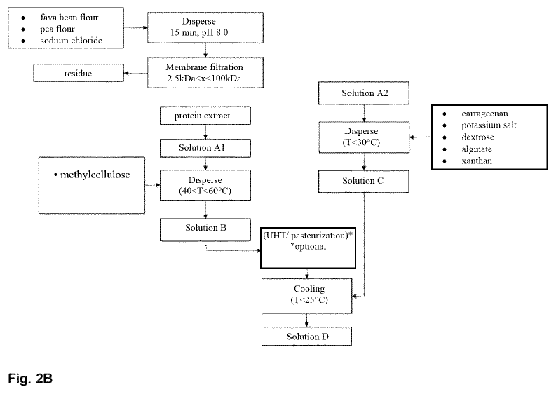

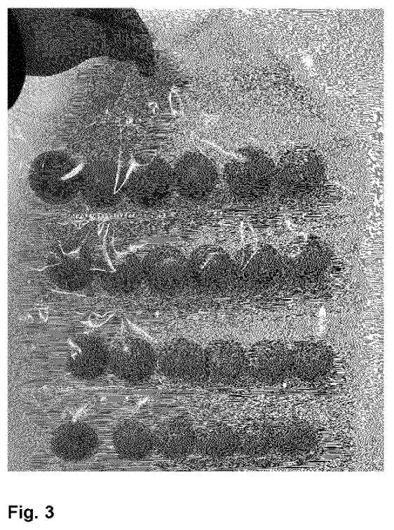

FIG. 3: diagrams showing a frozen egg yolk substitute product bead

FIG. 4; diagram for encapsulating the egg yolk and introducing it into the egg white

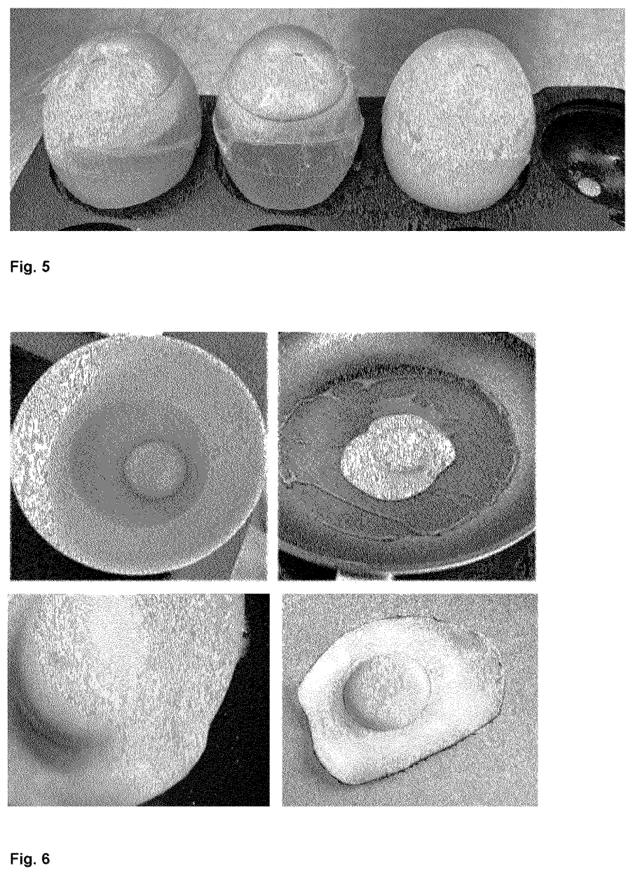

FIG. 5: Production of an egg yolk substitute and egg white substitute (different formulations) into an egg shell substitute

FIG. 6: Production of a fried egg with egg substitute product according to the invention

The following examples describe egg substitute products according to the invention in fried egg form. These do not represent a limitation to precisely these embodiments.

### Example 1

Example 1A

| | |
|---|---|
| Water | 67.28% |
| Yam puree | 5.49% |
| Pea protein isolate | 3.25% |
| Hydroxypropylmethylcellulose | 1.00% |
| Carrageenan | 0.90% |
| Calcium lactate | 0.74% |
| Potassium chloride | 0.10% |
| Kala namak | 0.74% |
| Rapeseed oil | 20.0% |
| β-carotene | 0.50% |

For encapsulation 0.75% sodium alginate solution
The production takes place as shown in the diagram of FIG. 1A.

Example 1B

| | |
|---|---|
| Water | 66.1% |
| Yam puree | 6% |
| Fava bean protein isolate | 3.25% |
| Pea protein isolate | 4.5% |
| Methylcellulose | 1.2% |
| Carrageenan | 0.85% |
| Dextrose | 0.1% |
| Potassium chloride | 0.1% |
| Sodium chloride | 0.1% |
| Sunflower oil | 15% |
| β-carotene | 0.2% |
| Carrot extract | 0.75% |
| Natural flavor 1 | 1% |
| Natural flavor 2 | 0.85% |

For encapsulation Sprayed calcium chloride on frozen beads (see method 4)
1.0% warm (30 < T < 60 °C) sodium alginate solution
The production takes place as shown in the diagram of FIG. 1B.

### Example 2

Example 2A

| | |
|---|---|
| Water | 81.10% |
| Pea protein isolate | 15.00% |
| Methylcellulose | 1.50% |
| Carrageenan | 1.50% |
| Alginate | 0.25% |
| Dextrose | 0.25% |
| Potassium chloride | 0.15% |
| Kala namak | 0.25% |

The production takes place as shown in the diagram of FIG. 2A.

Example 2B

| | |
|---|---|
| Water | 73.62% |
| Fava bean flour | 8.00% |
| Pea flour | 15.00% |
| Sodium chloride | 0.08% |
| Methylcellulose | 1.50% |
| Carrageenan | 0.85% |
| Alginate | 0.35% |
| Xanthan | 0.15% |
| Dextrose | 0.25% |
| Potassium chloride | 0.20% |

The production takes place as shown in the diagram of FIG. 2B.

1. A vegan-based egg substitute product, comprising a mixture (1) of:
(a) 1-35 wt % of a protein derived from pulses, oilseeds, grains, algae, or microorganisms,
(b) 1-50 wt % of vegetable oil, optionally containing an emulsifier,
(c) 0.14.5 wt. % of a combination of a reversibly thermo-gelling hydrocolloid selected from methylcelluloses, hydroxyethylcelluloses, hydroxypropylmethylcelluloses, and/or hydroxypropylcelluloses with a reversibly gelling hydrocolloid selected from agar and/or carrageenan,
(d) less than 12 wt. % of a carotenoid-containing food, wherein yam is present as a carotenoid-containing food in an amount of 3.0-10.0 wt %
(e) less than 0.5 wt % of a partially pregelatinized starch
(f) less than 0.75 wt. % of salt,
(g) the rest being drinking water,
wherein the mixture (1) is enclosed by a shell of a highly crosslinked hydrocolloid or thermoreversibly gel-forming hydrocolloid, which in turn is surrounded by a mixture (2), comprising:
(i) 0.1 wt %-15 wt % of a proteins derived from pulses, oilseeds, grains, microorganisms, and/or algae,
(ii) less than 5 wt % of a combination of a reversibly thermo-gelling hydrocolloids selected from methylcelluloses, hydroxyethylcelluloses, hydroxypropylmethylcelluloses, and/or hydroxypropylcelluloses with a reversibly gelling hydrocolloids selected from agar and/or carageen,
(iii) less than 0.75 wt. % of salt,
(iv) the rest being drinking water.

2. The egg substitute product according to claim 1, wherein the shell is composed of calcium alginate or k-carrageenan.

3. The egg substitute product according to claim 1, wherein the mixture (1) and/or (2) further comprises a salt and/or flavoring formulation containing sulfur compounds or salts.

4. The egg substitute product according to claim 1, wherein the mixture (1) and/or (2) further comprises a seasoning or flavoring formulation.

5. The egg substitute product according to claim 1, wherein the hydrocolloid (c) or (ii) is a combination of methylcellulose and carrageenan.

6. The egg substitute product according to claim 1, wherein the vegetable oil (b) is corn germ oil, rapeseed oil, coconut oil, and/or sunflower oil.

7. The egg substitute product according to claim 1, wherein the plant protein is (a) or (i) pea protein, lupin protein, potato protein, chickpea protein, oat protein, rice protein, wheat protein, and/or fava bean protein.

8. The egg substitute product according to claim 7, wherein the plant protein is a (hydrolyzed) flour, protein concentrate, protein isolate, and/or any combinations thereof.

9. The egg substitute product according to claim 1, wherein the mixture (1) further contains a natural coloring substance in addition to the carotenoid-containing food.

10. (canceled)

11. The egg substitute product according to claim 1, wherein the oil (b) contains an emulsifier selected from lecithin, ascorbyl palmitate, sodium phosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate, or sorbitan monostearate.

12. (canceled)

13. The egg substitute product according to claim 1, wherein the amount of hydrocolloids in mixture (2) is 0.5 wt %-2.5 wt %.

14. The egg substitute product according to claim 1, wherein the mixture (2) additionally comprises sugar in an amount of 0.10 wt %-1.00 wt. %.

15. A method for the preparation of an egg substitute product according to claim 1, wherein a unit of an egg yolk substitute product according to mixture (1) is metered by means of a suitable metering device into a container filled with egg white substitute product according to mixture (2) and the amount of egg white substitute product is selected such that the ratio of egg yolk substitute product to egg white substitute product corresponds approximately to that of an animal egg.

16. A component of an emulsion or a liquid comprising at least one phase as an ingredient in a meal or baked goods or a simulated fried egg comprising the egg substitute product of claim 1.

17. The component according to claim 16, wherein the product is a component of a vegan emulsion or a liquid comprising at least one phase, as an ingredient in a vegan meal or vegan baked goods.

18. The component according to claim 16, wherein the product is a component of a non-vegan emulsion or a liquid comprising at least one phase, as an ingredient in a non-vegan meal or non-vegan baked goods.
